(19) United States
(12) Patent Application Publication
(10) Pub. No.: US 2016/0239759 A1
(43) Pub. Date: Aug. 18, 2016

(54) METHOD AND APPARATUS ESTIMATING STATE OF BATTERY

(71) Applicant: Samsung Electronics Co., Ltd., Suwon-si (KR)

(72) Inventor: Jaemo SUNG, Hwaseong-si (KR)

(73) Assignee: Samsung Electronics Co., Ltd., Suwon-si (KR)

(21) Appl. No.: 14/970,823

(22) Filed: Dec. 16, 2015

(30) Foreign Application Priority Data
Feb. 17, 2015 (KR) 10-2015-0024195

(51) Int. Cl. G06N 99/00; G06N 7/00; H01M 10/42

(52) U.S. Cl. CPC G06N 99/005; H01M 10/4285; G06N 7/005

(57) ABSTRACT

A method and an apparatus for estimating a state of a battery are provided. A received battery signal may be segmented into sets of segment data at a predetermined time interval, and a state of a battery may be estimated using an estimated battery state probability value of the segment data.

### CROSS-REFERENCE TO RELATED APPLICATION

This application claims the benefit under 35 USC 119(a) of Korean Patent Application No. 10-2015-0024195, filed on Feb. 17, 2015, in the Korean Intellectual Property Office, the entire disclosure of which is incorporated herein by reference for all purposes.

### BACKGROUND

1. Field

One or more embodiments of the following description relate to a method and an apparatus estimating a state of a battery, such as by considering a signal pattern of a voltage, a current, a temperature, and the like of the battery.

2. Description of Related Art

Amid the growing importance of environmental concerns and energy resource issues, electric vehicles are receiving attention as a future form of transportation. An electric vehicle (EV) may use a battery as a main power source, with the battery typically including chargeable and dischargeable secondary cells formed in a single pack. Thus, electric vehicles may emit no exhaust fumes and an extremely low amount of noise.

In such an EV, the battery may operate as a fuel tank would for an engine of a gasoline powered vehicle. Thus, to enhance a safety of a user of the EV, checking a state of the battery may be important.

Recently, research is being conducted to increase a convenience of a user while more accurately monitoring a state of a battery.

### SUMMARY

This Summary is provided to introduce a selection of concepts in a simplified form that are further described below in the Detailed Description. This Summary is not intended to identify key features or essential features of the claimed subject matter, nor is this Summary intended to be used as an aid in determining the scope of the claimed subject matter.

One or more embodiments include an apparatus for learning a battery state estimation model, including a signal processor configured to segment a battery signal into sets of segment data at a predetermined time interval, and a learner, as one or more processing devices, configured to learn a battery state estimation model, for estimating a battery state of a battery, based on a determined battery state probability density of the segment data.

The battery state may be at least one of an overdischarge event, a state of health (SoH), a state of charge (SoC), a state of function (SoF), and a fault state.

The signal processor may include a preprocessor configured to correct the battery signal so that an interval that the battery signal was collected from the battery is changed to a regular time interval and configured to perform an elimination of noise from the battery signal.

The learner may include a feature space transformation model learner configured to learn a feature space transformation model corresponding to a battery state feature by projecting the sets of the segment data to a corresponding feature space, a battery state probability density model learner configured to learn the battery state probability density model to estimate a battery state probability value using the learned feature space transformation model, and a battery state estimation model learner configured to learn the battery state estimation model to estimate a battery state using the battery state probability density model.

The feature space transformation model learner may be configured to learn the feature space transformation model by projecting the sets of the segment data to the corresponding feature space in a dimension lower than a current dimension of the segment data, using at least one of a principle component analysis, a linear discriminant analysis, a nonnegative matrix factorization, and an independent component analysis.

The battery state probability density model learner may be configured to estimate a parameter of the battery state probability density model defined by at least one of a maximum likelihood algorithm and a maximum a posteriori (MAP) algorithm using the learned feature space transformation model.

The learner may be configured to determine a threshold value parameter that indicates a battery state to be a normal state in response to an estimated battery state probability value meeting a predetermined threshold value based on the determined battery state probability density corresponding to the learned battery state estimation model, and configured to reflect the determined threshold value parameter in the battery state estimation model.

One or more embodiments include a battery state estimating apparatus, including a signal processor configured to segment a battery signal into sets of segment data at a predetermined time interval, and a state estimator, as one or more processing devices, configured to estimate a battery state of a battery based on an estimated battery state probability value of the segment data with respect to a learned battery state estimation model.

The battery state may be at least one of an overdischarge event, a state of health (SoH), a state of charge (SoC), a state of function (SoF), and a fault state.

The signal processor may include a preprocessor configured to correct the battery signal so that an interval that the battery signal was collected from the battery is changed to a regular time interval and configured to perform an elimination of noise from the battery signal.

The state estimator may be configured to estimate the battery state based on an average of battery state probability values estimated from successive sets of the segment data.

The learned battery state estimation model may include a battery state probability density model learned using reference segment data of a battery signal previously measured from a reference battery.

The state estimator may include a feature extractor configured to extract a feature of the battery state by projecting the segment data to a feature space, and a battery state probability inferrer configured to infer a probability of the battery state using a battery state probability density model corresponding to the battery state.

The apparatus may further include a learner configured to learn the battery state estimation model using a determined battery state probability density of reference segment data.

The learner may further include a feature space transformation model learner configured to learn a feature space transformation model corresponding to a battery feature state by projecting sets of the reference segment data to a feature space, a battery state probability density model learner configured to learn a battery state probability density model to estimate the battery state probability value using the learned feature space transformation model, and a battery state estimation model learner configured to learn the battery state estimation model for estimating battery states using the learned battery state probability density model.

One or more embodiments include a battery state estimating method, including segmenting a battery signal into sets of segment data at a predetermined time interval, calculating an estimated battery state probability value of the segment data with respect to a learned battery state estimation model, and estimating a battery state of a battery based on the calculated estimated battery state probability value.

The segmenting may include correcting the battery signal so that an interval that the battery signal was collected from the battery is changed to a regular time interval, and performing an elimination of noise from the battery signal.

The learned battery state estimation model may be generated from a battery state probability density model learned using reference segment data of a battery signal previously measured from a reference battery.

The method may further include learning the battery state estimation model based on the learned battery state probability density model.

The battery state probability density model may include a normal state estimation model corresponding to a normal state of the reference battery and an abnormal state estimation model corresponding to an abnormal state of the reference battery.

The battery state probability density model may be generated from a feature space transformation model corresponding to a feature of the battery state by projecting the reference segment data to a corresponding feature space.

The method may further include learning the feature space transformation model by projecting the reference segment data into a lower dimension using at least one of a principle component analysis, a linear discriminant analysis, a nonnegative matrix factorization, and an independent component analysis.

One or more embodiments include a non-transitory computer-readable storage medium including computer readable code to control at least one processing device to implement one or more embodiments disclosed herein.

Other features and aspects will be apparent from the following detailed description, the drawings, and the claims.

### BRIEF DESCRIPTION OF THE DRAWINGS

FIG. 1 is a diagram illustrating a battery module and an apparatus learning a battery state estimation model, according to one or more embodiments.

FIG. 2 is a diagram illustrating a learner of an apparatus learning a battery state estimation model, according to one or more embodiments.

FIG. 3 is a diagram illustrating a signal processor processing a battery signal to be segment data, according to one or more embodiments.

FIG. 4 is a diagram illustrating a sequence through which a battery state estimation model may be generated from segment data, according to one or more embodiments.

FIG. 5 is a graph illustrating an example of signal processing and feature space transformation, such as performed by an apparatus for learning a battery state estimation model, according to one or more embodiments.

FIG. 6 is a diagram illustrating a method of learning a battery state probability density model using a maximum a posteriori (MAP) algorithm, such as by an apparatus for learning a battery state estimation model, according to one or more embodiments.

FIG. 7 is a diagram illustrating a method of learning a threshold value of a battery state estimation model using a battery state probability density model, such as by an apparatus for learning a battery state estimation model, according to one or more embodiments.

FIG. 8 is a diagram illustrating a battery state estimating apparatus, according to one or more embodiments.

FIG. 9 is a flowchart illustrating a battery state estimating method, according to one or more embodiments.

Throughout the drawings and the detailed description, unless otherwise described or provided, the same drawing reference numerals refer to like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, after an understanding of the present disclosure, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that may be well known to one of ordinary skill in the art may be omitted for increased clarity and conciseness.

The features described herein may be embodied in different forms, and are not to be construed as being limited to the examples described herein.

Various alterations and modifications may be made to the exemplary embodiments, some of which will be illustrated in detail in the drawings and detailed description. However, it should be understood that these embodiments are not construed as limited to the illustrated forms and include all changes, equivalents or alternatives within the idea and the technical scope of this disclosure.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “include” and/or “have,” when used in this specification, specify the presence of stated features, integers, operations, elements, components or combinations thereof, but do not preclude the presence or addition of one or more other features, integers, operations, elements, components, and/or groups thereof.

Unless otherwise defined, all terms including technical and scientific terms used herein have the same meaning as commonly understood by one of ordinary skill in the art to which this invention belongs, in view of the present disclosure. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

Hereinafter, exemplary embodiments will be described in detail with reference to the accompanying drawings, wherein like reference numerals refer to like elements throughout. When it is determined a detailed description of a related known function or configuration may make a purpose of an embodiment of the present disclosure unnecessarily ambiguous in describing the embodiment, the detailed description may be omitted herein.

One or more embodiments, and only as an example, relate to technology that learns a battery state probability density model with a normal or abnormal state pattern of a battery based on sets of battery sensor data of a voltage, a current, a temperature, and/or a pressure, as only examples, and that detects and monitors a normal or abnormal state of a battery based on the learned battery state probability density model.

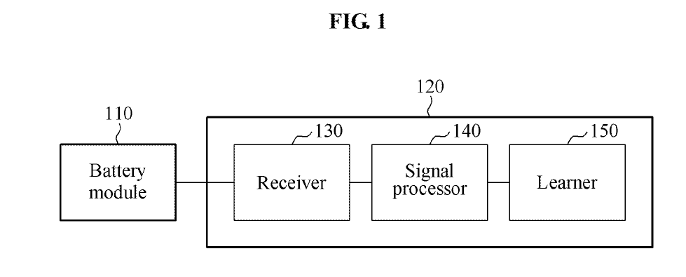

FIG. 1 is a diagram illustrating a battery module and an apparatus learning a battery state estimation model, according to one or more embodiments. Hereinafter, the apparatus learning a battery state estimation model will be referred to as a battery state estimation model learning apparatus. In addition, as noted below, such a battery state estimation model learning apparatus may be included in a battery state estimation apparatus.

Referring to FIG. 1, a battery state estimation model learning apparatus 120 may receive a battery signal, e.g., from a battery module 110, and may learn a battery state estimation model based on that battery signal.

The battery module 110 may include a secondary cell, such as a lithium-ion battery, and, in one or more embodiments, may provide power to a driving motor, for example, the electric drive system of an electric vehicle embodiment.

The battery module 110 may include a battery, such as the example lithium-ion battery, and one or more sensors. Alternatively, such sensors may not be included in the battery module 110, but disposed separately from the battery module 110. For example, the sensors may be included in the battery state estimation model learning apparatus 120.

The sensor may obtain or measure physical characteristics of the battery, such as one or more battery signals of the battery. As only examples, the battery signal may include any one, or any combination, of voltage data, current data, temperature data, and pressure data of the battery. In one or more embodiments, the sensor may measure the battery signal in real time, and may also measure the battery signal in real time irrespective of a type of the battery, a cause of an error of the battery, and the like.

As illustrated in FIG. 1, the battery state estimation model learning apparatus 120 may include a receiver 130, a signal processor 140, and a learner 150, for example.

The receiver 130 may receive the battery signal(s) from the battery module 110, e.g., from the sensor(s) of the battery module 110. Alternatively, the receiver 130 obtains the battery signal(s) from the sensor(s) included in the battery state estimation model learning apparatus 120.

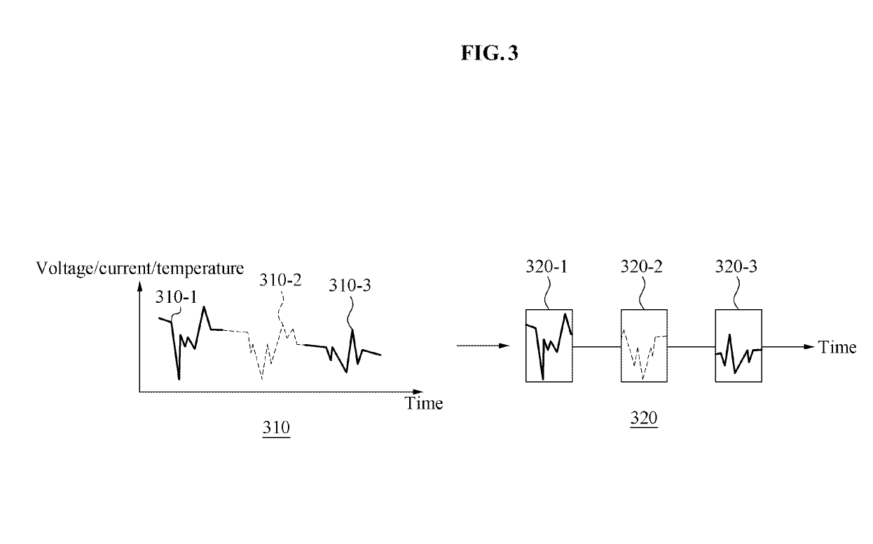

The signal processor 140 segments the battery signal into respective sets of segment data at a predetermined time interval, such as demonstrated below in FIG. 3.

In an embodiment, the signal processor 140 includes a preprocessor element. The preprocessing may eliminate noise from a received time-series battery signal, i.e., the battery signal successively measured by the sensor. The preprocessing may correct, to be a regular time interval, irregular sensed intervals of the received battery signal that may occur due to degradation of the sensor and/or a delay in signal transmission, for example. In an embodiment, this preprocessing may be implemented through software.

Alternatively, in an embodiment, the preprocessor element may be included in the battery module 110. As another example, a corresponding preprocessor or preprocessing element may be disposed externally from the battery state estimation model learning apparatus 120 and the battery module 110, for example, in a personal computer (PC), a server, or implemented through cloud computing.

The signal processor 140 may segment the successive battery signal, e.g., of a fixed magnitude for a predetermined amount of time, into the sets of the segment data in block units. The signal processor 140 may further extract, from the successively sensed time-series battery signal, respective segment data including D-dimensional successive sets of data for the predetermined time interval.

Here, the battery signal may refer to a signal with a high-dimensional time-series characteristic. The dimension of a signal having such a time-series characteristic may continuously increase as sensing progresses. However, generating data models in such a variable high-dimensional time-series signal space may require a highly complex processor or processing and result in high costs. Thus, the signal processor 140 may transform the segment data, representing the variable high-dimensional time-series battery signal, to a fixed-dimensional segment data space.

Accordingly, the learner 150 may learn a battery state estimation model for the battery based on a battery state probability density of the reduced dimension sets of the segment data. Thus, the learner 150 may learn the battery state estimation model corresponding to the battery state, for example, a normal and an abnormal state, based on the segment data in block units.

The battery state may include at least one of information on a battery overdischarge event, a state of health (SoH) of the battery, a state of charge (SoC) of the battery, a state of function (SoF) of the battery, a fault state of the battery, and the like. Thus, a battery state estimating apparatus may use the battery state estimation model to estimate such a battery state of the battery module 110.

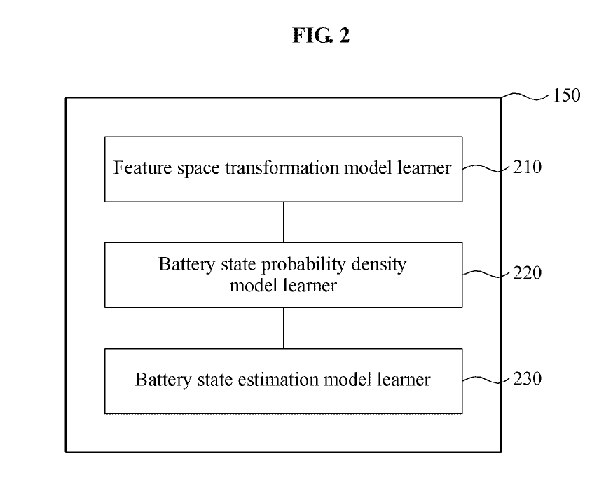

Here, in addition to the above, the learner 150 may learn parameters of models, such as for the feature space transformation model, the battery state probability density model, and/or battery state estimation model, based on segment data of a reference battery, for example, such as obtained by a battery state estimation model learner discussed below in FIG. 2. These parameters may be respectively used when the models are being used for estimating a state of the battery, for example.

FIG. 2 is a diagram illustrating a learner of a battery state estimation model learning apparatus, such as the learner 150 of the battery state estimation model learning apparatus 120 of FIG. 1, according to one or more embodiments. Though the learner is described with reference to the battery state estimation model learning apparatus 120 of FIG. 1, this is done for convenience of explanation, and embodiments are not limited thereto.

Referring to FIG. 2, the learner 150 may include a feature space transformation model learner 210, a battery state probability density model learner 220, and a battery state estimation model learner 230, for example.

The feature space transformation model learner 210 may learn an optimal, for example, feature space transformation model based on sets of segment data of a reference battery. The feature space transformation model may include at least one low-dimensional projection model of a principle component analysis (PCA), a linear discriminant analysis, a nonnegative matrix factorization, and an independent component analysis, for example.

The battery state probability density model learner 220 may generate a battery state probability density model associated with a normal or abnormal state from a feature data vector set of the segment data collected from the reference battery in a normal state. The battery state probability density model learner 220 may generates a battery state probability density model on the normal state from a feature data vector set extracted from the reference battery in the normal state, and a battery state probability density model on the abnormal state from a feature data vector set extracted from the reference battery in the abnormal state.

Thus, the battery state estimation model learner 230 may learn an optimal, for example, parameter value of a battery state estimation model based on battery state probability values inferred from the sets of the segment data collected from the reference battery. Such as discussed above with reference to FIG. 1, this example optimal parameter value may be used by the battery state estimation model along with segment data of received battery signal(s) from a battery module to estimate a battery state of a battery.

FIG. 3 is a diagram illustrating a signal processor processing a battery signal to be segment data, according to one or more embodiments.

Referring to FIG. 3, the signal processor segments a battery signal 310 into sets of segment data 320 in predetermined time intervals. For example, as illustrated in FIG. 3, from a battery signal 310-1, a battery signal 310-2, and a battery signal 310-3, the signal processor may respectively generate segment data 320-1, segment data 320-2, and segment data 320-3.

The battery signal 310 may include any one, or any combination, of a voltage signal, a current signal, and a temperature signal, as only examples, of a battery based on a time.

The signal processor may preprocess the battery signal 310 obtained from a corresponding time-series battery signal, e.g., received from one or more sensors, to be in a form suitable for data processing, and generate the segment data 320 including successive signals of a fixed magnitude for a predetermined amount of time. Here, the preprocessing by the signal processor may eliminate noise from the time-series battery signal successively measured by the sensor(s). The preprocessing of the signal processor may also, or alternatively, correct irregular intervals for sensing a battery signal that may occur due to degradation of the sensor and/or a delay in signal transmission to be a regular time interval, e.g., through use of software.

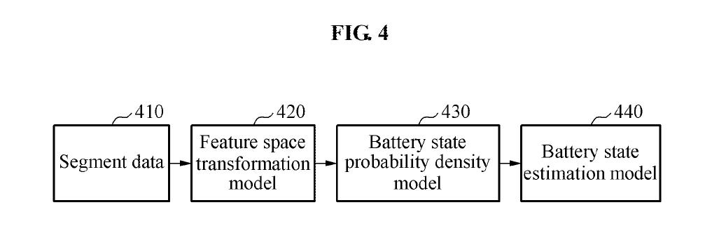

FIG. 4 is a diagram illustrating a sequence through which a battery state estimation model may be generated from segment data, according to one or more embodiments.

Referring to FIG. 4, using segment data 410, a feature space transformation model 420 and a battery state probability density model 430 may be used to generate a battery state estimation model 440.

As discussed above, a signal processor may generate, or have previously generated, sets of the segment data 410 by segmenting a battery signal at regular time intervals. Here, the signal processor may be of a system such as in FIG. 1, or of a reference system where the segment data 410 may be reference segment data from a battery signal from a reference battery. Accordingly, this segment data 410 may be reference segment data currently or previously derived from a battery module, such as illustrated in FIG. 1, or reference segment data that is or was derived from a reference battery or battery module. The reference segment data may be stored locally or stored/obtained to/from a remote server, for example.

A learner may generate the feature space transformation model 420 based on the sets of the segment data 410. The learner may generate the feature space transformation model 420 by extracting a feature of the segment data 410. The extracting of the feature may be implemented through the below Equation 1, as only an example.

Xₜ=f(Sₜ) Equation 1:

In Equation 1, “t” denotes a time, “S” denotes segment data, and “X” denotes a discriminant feature of the segment data. Here, the feature space transformation model 420 may be learned by projecting the segment data 410 to a low dimension using at least one of a PCA, a linear discriminant analysis, a nonnegative matrix factorization, and an independent component analysis, for example. The feature space transformation model 420 may be generated by selectively extracting only necessary data, for example, from a low-dimensional segment data vector. Through such a low-dimensional model, the learner may transform data present in a D-dimensional segment data space to a lower K-dimensional space in which a difference between a normal pattern and an abnormal pattern is extremely discriminable while minimizing a loss of information.

In addition, here, the feature space transformation model 420 may be generated by automatically estimating an optimal, for example, model parameter from the segment data 410 through a machine learning method.

As only examples, the feature space transformation model 420 may include an SoH estimation model, an SoC estimation model, a capacity estimation model, and an internal resistance estimation model based on the sets of the segment data 410. The feature space transformation model 420 may add battery characteristics such as an SoH, an SoC, a capacity, and an internal resistance as an element of a feature data vector, as only examples.

The learner may learn the battery state probability density model 430 based on the feature space transformation model 420. Accordingly, the battery state probability density model 430 may be defined in this feature space, and defined as a probability distribution model such as a probability mixture model and a hidden Markov model (HMM).

The learner may generate the battery state probability density model 430 associated with a normal or abnormal state in the feature space from the feature space transformation model 420 extracted from a battery in a normal state. Here, in an embodiment, the learner may learn the battery state probability density model 430 by estimating a parameter of the battery state probability density model 430 defined by at least one of a maximum likelihood and a maximum a posteriori (MAP) algorithm, for example, using the feature space transformation model 420.

In a case of feature vector data generated during an operation of the battery in the normal state, the battery state probability density model 430 may represent a high probability value. Conversely, in a case of feature vector data generated during an operation of a battery in the abnormal state, the battery state probability density model 430 may represent a low probability value.

The learner may generate the battery state estimation model 440 based on the battery state probability density model 430. The battery state estimation model 440 may include a normal state estimation model and an abnormal state estimation model. For example, the normal state estimation model may be generated using the battery state probability density model 430 with a normal state probability pattern, and the abnormal state estimation model may be generated using the battery state probability density model 430 with an abnormal state probability pattern.

For example, in an embodiment, the battery state estimation model 440 may be defined as a model representing a pattern difference between a pattern of a battery state probability value with respect to the feature vector data generated during the operation of the battery in the normal state and a pattern of a battery state probability value with respect to the feature vector data generated during the operation of the battery in the abnormal state.

The battery state estimation model 440 may include a threshold value model. Estimating a battery state based on the threshold value model may be a method that includes determining the battery state to be a normal state when an estimated normal state probability value is determined to meet a predetermined threshold value, and determining the battery state to be an abnormal state when the estimated normal state probability value is determined to not meet the threshold value. For example, in an embodiment, the battery state may be determined to be the normal state when the estimated normal state probability value is determined to be greater than or equal to the predetermined threshold value, and the battery state may be determined to be an abnormal state when the estimated normal state probability value is determined to be less than the threshold value, as only examples.

In an embodiment, this learning of the threshold value model may be performed by determining an optimal threshold value from the battery state probability density model 430. A candidate threshold value may be determined based on the battery state probability value estimated with respect to the feature vector data generated during the operation of the battery in the normal state and the battery state probability value estimated with respect to the feature vector data generated during the operation of the battery in the abnormal state. Here, a degree of accuracy in estimating the battery state may be measured based on each candidate threshold value. A candidate threshold value having an optimal, for example, degree of accuracy may be determined to be the optimal threshold value model.

Additionally, in one or more embodiments, any of the threshold value model, a machine learning classification model, for example, a support vector machine (SVM), a decision tree, a neural network, and/or a Naive Bayes classification, as only examples, may be used for the battery state estimation model 440 based on the probability value estimated for each battery state.

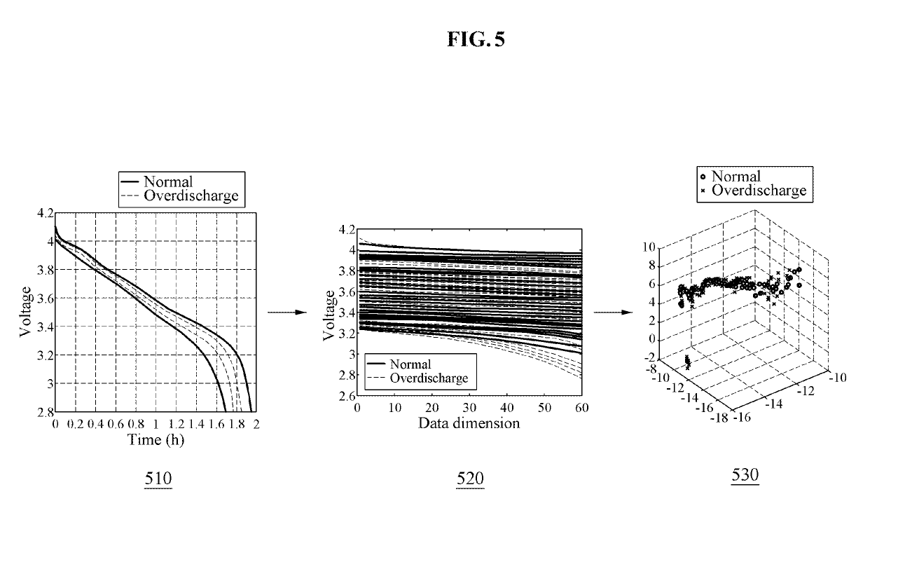

FIG. 5 is a graph illustrating an example of signal processing and feature space transformation, such as performed by a battery state estimation model learning apparatus, according to one or more embodiments.

FIG. 5 illustrates a battery signal graph 510, a segment data graph 520, and a feature space transformation model 530, for example.

In the battery signal graph 510, a normal state voltage curve is indicated by a solid line, and an overdischarge state voltage curve is indicated by a broken line. Here, as shown in segment graph 520, 60-dimensional segment data including information of a five minute interval may be extracted by segmenting a time-series discharge voltage signal in a normal state and an abnormal state by an overdischarge event.

The feature space transformation model 530 indicates data obtained by projecting the segment data graph 520 to a feature space through a learned three-dimensional PCA. Thus, through segmentation, a time-series signal space model having a variable length characteristic may be transformed to a fixed-dimensional, for example, a D-dimensional, space of a segment block unit. The feature space transformation model 530, through the PCA, may compressively represent segment data information in a low-dimensional space while minimizing loss of information and thus, may considerably reduce a quantity of computation in subsequent data processing compared to an example embodiment where the segment data is not feature transformed. In this PCA example, this compressive representation of the segment data can be accomplished because the PCA may define a battery state probability density model in the low-dimensional space and thus, may reduce a number of parameters of the battery state probability density model.

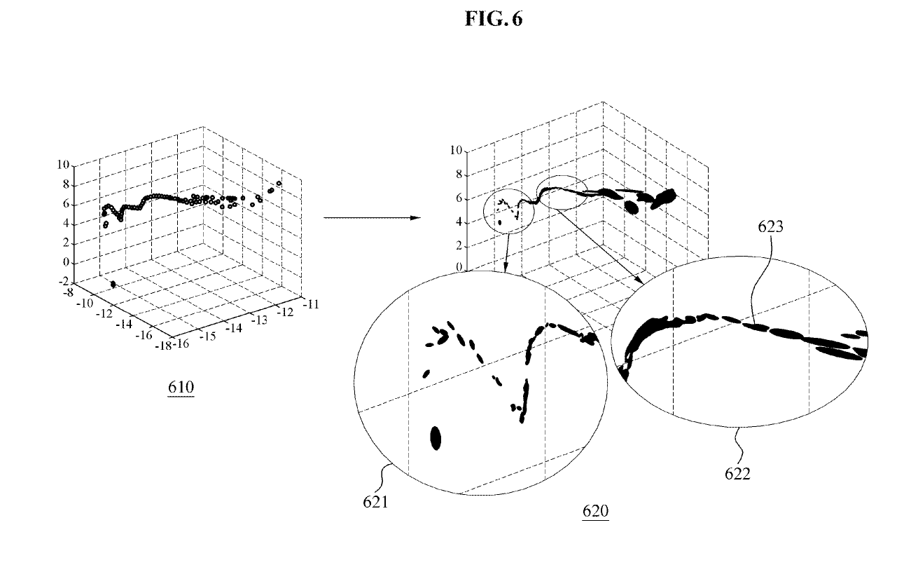

FIG. 6 is a diagram illustrating a method of learning a battery state probability density model using an MAP algorithm, such as by a battery state estimation model learning apparatus, according to one or more embodiments. For only explanatory purposes, and only as an example, this method of learning the battery state probability density model will be described with reference to a battery state estimation model learning apparatus, noting that embodiments are not limited thereto.

Referring to FIG. 6, the battery state estimation model learning apparatus may learn a Gaussian mixture model 620 as a battery state probability density model of a normal state, using a feature space transformation model 610 through PCA of the normal state. Here, the battery state estimation model learning apparatus may learn a parameter of a data-based Gaussian mixture model based on the MAP algorithm or an expectation-maximization learning algorithm. In an example, the battery state estimation model learning apparatus may verify a result of learning the Gaussian mixture model 620 including 150 Gaussian components 623 based on the MAP algorithm. The Gaussian mixture model 620 of the normal state may represent a probability distribution pattern of a normal state data pattern 622 and thus, may represent a high probability value for the normal state data pattern 622 and represent a low probability value for a data pattern 621 that deviates from the normal state data pattern 622. That is, the Gaussian components 623 may represent the high probability value for the normal state data pattern 622, and represent the low probability value for the data pattern 621 that deviates from the normal state data pattern 622.

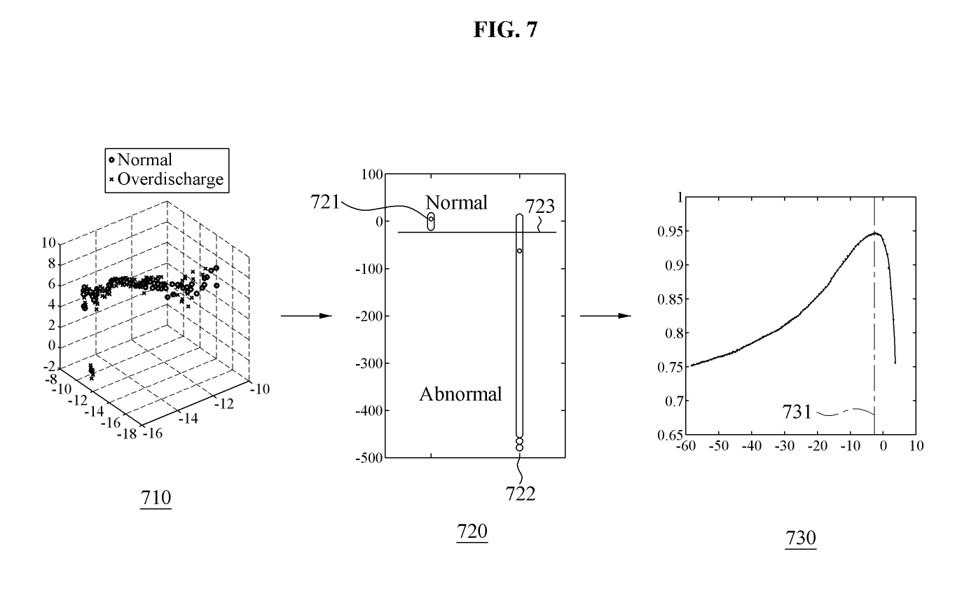

FIG. 7 is a diagram illustrating a method of learning a threshold value of a battery state estimation model using a battery state probability density model, such as by a battery state estimation model learning apparatus, according to one or more embodiments. For only explanatory purposes, and only as an example, this method of learning the threshold value of the battery estimation model will be described with reference to a battery state estimating apparatus, e.g., which includes such a battery state estimating model learning apparatus, noting that embodiments are not limited thereto.

FIG. 7 illustrates a Gaussian mixture model 710, e.g., included in the battery state probability density model, a threshold value estimation model 720, and an optimal threshold value model 730.

The battery state estimating apparatus may detect a normal or an abnormal battery state using the threshold value estimation model 720 based on the Gaussian mixture model 710 of the normal battery state. In addition, the battery state estimating apparatus may learn a threshold value parameter of the threshold value estimation model 720 based on sets of learning data.

The battery state estimating apparatus based on the threshold value estimation model 720 may infer a normal state probability value 721, which is a value probability that feature space transformation data of segment data indicates the normal battery state, based on the learned Gaussian mixture model 710 of the normal battery state.

The battery state estimating apparatus may infer the normal state probability value 721 using an average of normal state probability values inferred from successive sets of the segment data, for example. A candidate threshold value 723 of the threshold value estimation model 720 may be determined based on the normal state probability value 721. Here, when an overdischarge battery state probability value 722 meets, or is greater than or equal to, the candidate threshold value 723, the battery state estimating apparatus may determine the normal battery state. Conversely, when the overdischarge battery state probability value 722 fails to meet, or is less than, the candidate threshold value 723, the battery state estimating apparatus may determine the abnormal battery state.

An optimal threshold value may be set to ensure accuracy of the battery state estimating apparatus based on the threshold value estimation model 720. The battery state estimating apparatus may infer the normal state probability value 721 using the Gaussian mixture model 710 of the normal battery state, which may be learned with respect to a feature space transformation model of the normal battery state and a feature space transformation model of the abnormal battery state subsequent to an overdischarge event. The battery state estimating apparatus may define a plurality of candidate threshold values within a normal state probability value range with respect to the feature space transformation model of the normal battery state and the feature space transformation model of the abnormal battery state. Using the threshold value estimation model 720 for each candidate value, the battery state estimating apparatus may measure accuracy in detecting the normal or the abnormal battery state corresponding to each candidate threshold value by utilizing a set of normal state learning data and a set of abnormal state learning data. The optimal threshold value model 730 may estimate a candidate threshold value having an optimal accuracy to be an optimal threshold value 731 of the threshold value estimation model 720 based on the accuracy in detecting the normal or the abnormal battery state corresponding to each candidate threshold value.

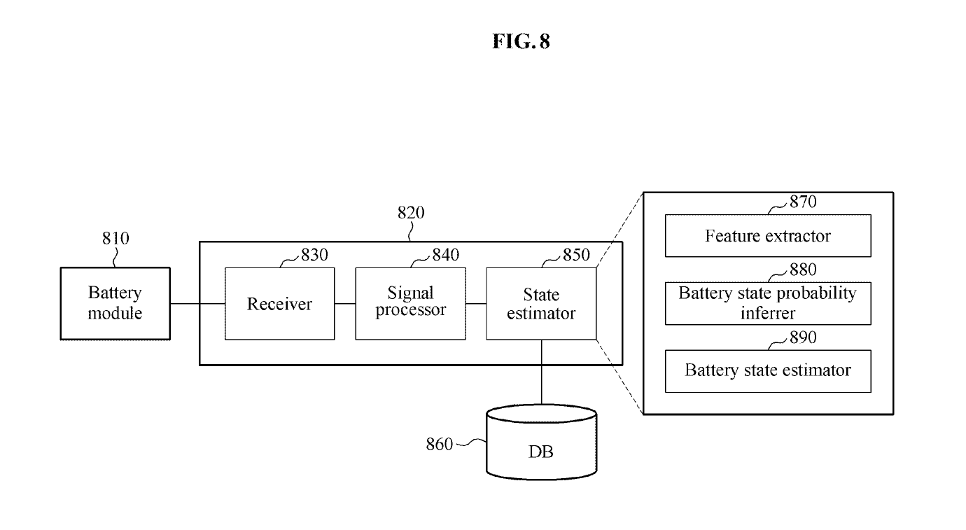

FIG. 8 is a diagram illustrating a battery state estimating apparatus, according to one or more embodiments.

Referring to FIG. 8, the battery state estimating apparatus 820 may estimate a battery state based on a battery signal received from a battery module 810.

The battery module 810 may include a battery and one or more sensors to monitor the battery. The battery state estimating apparatus 820 may include one or more such sensors for monitoring the battery. Additionally, the sensor may not be included in the battery module 810, but disposed separately from the battery module 810, and included in the battery state estimating apparatus 820 or elsewhere in the electronic device embodiment of FIG. 8 that includes the battery module 810 and the battery state estimating apparatus 820. Alternatively, the sensor may be included in a battery state estimation model learning apparatus, such as the battery state estimation model learning apparatus 120 of FIG. 1, included in the battery state estimating apparatus 820 and in lieu of the receiver 830, for example.

The sensor(s) may obtain or measure physical characteristics of the battery, such as one or more battery signals of the battery. The battery signal may include any one, or any combination, of voltage data, current data, temperature data, and pressure data of the battery, as only examples. In an embodiment, the sensor(s) may measure the battery signal in real time irrespective of a type of the battery and a cause of an error of the battery.

As illustrated in FIG. 8, the battery state estimating apparatus 820 may include the receiver 830, a signal processor 840, and a state estimator 850, for example. In an embodiment, the battery state estimating apparatus 820 may be connected to a database (DB) 860 that may include a battery state estimation model. Alternatively, the battery state estimating apparatus 820 may include such a database 860.

The receiver 830 may receive the battery signal(s) from the battery module 810, e.g., from the sensor(s) of the battery module 810. Alternatively, the receiver 830 may obtain the battery signal(s) from the sensor(s) included in the battery state estimating apparatus 820.

The signal processor 840 segments the battery signal into respective sets of segment data at a predetermined time interval.

In an embodiment, the signal processor 840 includes a preprocessor element. The preprocessing may eliminate noise from the received time-series battery signal successively measured by the sensor. The preprocessing may correct, to be a regular time interval, irregular intervals of the received battery signal that may occur, such as due to degradation of the sensor and/or a delay in signal transmission. In an embodiment, this preprocessing may be implemented through software, e.g., software to control at least one processing device of the signal processor 840 to implement the preprocessing.

Alternatively, in an embodiment, the preprocessor element may be included in the battery module 810. As another example, a corresponding preprocessor or preprocessing element may be disposed externally from the battery state estimating apparatus 820 and the battery module 810, for example, in a PC, a server, and implemented through cloud computing.

The signal processor 840 may segment the successive battery signal, e.g., of a fixed magnitude for a predetermined amount of time, into the sets of the segment data in a block unit. The signal processor 840 may further extract, from the successively sensed time-series battery signal, respective segment data including successive sets of data in a D-dimension for a predetermined time interval.

The database 860 may include a feature space transformation model, a battery state probability density model, and a battery state estimation model, for example, which may be learned by the battery state estimation model learning apparatus, such as in the battery state estimation model learning apparatus 120 of FIG. 1, and stored in the DB 860, for example.

The state estimator 850 may, thus, estimate in real time a battery state, for example, a normal or abnormal state, based on the segment data in the block unit.

As illustrated in FIG. 8, the state estimator 850 may include a feature extractor 870, a battery state probability inferrer 880, and a battery state estimator 890, for example.

The feature extractor 870 may selectively extract necessary or desired feature data from the D-dimensional segment data extracted from the battery module 810. Through a low-dimensional projection model, the D-dimensional segment data may be transformed from the D-dimensional segment data space to a K-dimensional space in which a normal and an abnormal pattern are extremely distinguishable while minimizing a loss of a quantity of information present in the D-dimensional segment data space. Thus, in a subsequent data processing operation, such as performed by the battery state probability inferrer 880, data processing may be more effectively performed with a lower quantity of computation with the K-dimensional space, e.g., compared to an example embodiment where such data subsequent data processing is attempted with the D-dimensional segment data.

The battery state probability inferrer 880 infers a normal or abnormal state probability value of the segment data in the low-dimensional feature space using the learned battery state probability density model of each battery state, for example, the normal and abnormal state. The inferred battery state probability value, for example, the normal and abnormal state probability value, may be a probability value inferred from a single set of the segment data or an average of probability values inferred from successive sets of the segment data.

The battery state estimator 890 estimates a current battery state based on the normal or abnormal state probability value inferred by the battery state probability inferrer 880. The battery state estimator 890 determines whether segment data extracted from a battery sensor signal follows a normal state probability pattern or an abnormal state probability pattern based on a prelearned battery state estimation model. The battery state estimating apparatus 820 may then output the estimated current battery state, e.g., to a display of an electronic vehicle embodiment herein that includes the battery state estimating apparatus 820.

Although two types of the battery state, the normal state and the abnormal state, are illustrated herein, other various types of the battery state may be applicable to the generating of the battery state probability density model and the inferring. As only examples, the battery state may include at least one of an overdischarge event, an SoH, an SoC, an SoF, and a fault state.

Any, or any combination, of the receiver 830, signal processor 840, and state estimator 850 may be at least one processing device, such as one or more processing devices that are configured to perform the corresponding operations or one or more processing devices that are controlled by computer readable code to implement such operations.

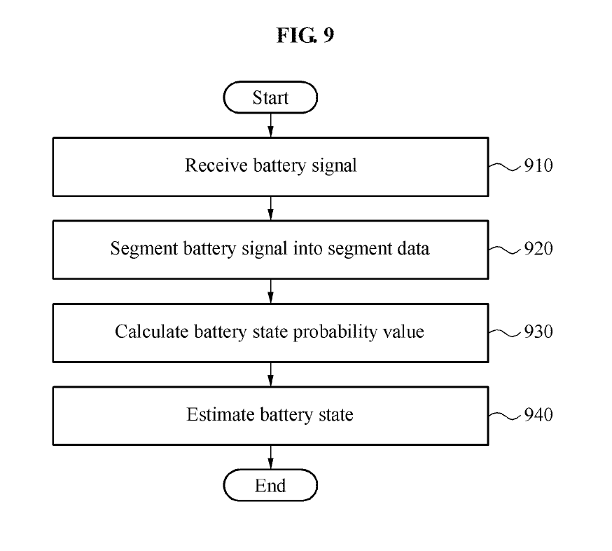

FIG. 9 is a flowchart illustrating a battery state estimating method, according to one or more embodiments. For only explanatory purposes, and only as an example, the battery state estimating method will be described hereinafter as being performed by a battery state estimating apparatus, noting that embodiments are not limited thereto.

Referring to FIG. 9, in operation 910, the battery state estimating apparatus may receive one or more battery signals from one or more sensors measuring characteristics of a battery. A battery signal may include a signal associated with any, or any combination, of a voltage, a current, a temperature, and a pressure of a battery, for example. In an embodiment, the sensor may measure, in real time, the battery signal irrespective of a type of the battery and a cause of an error in the battery.

In operation 920, the battery state estimating apparatus may segment the battery signal into sets of segment data at a predetermined time interval. In an embodiment, the battery state estimating apparatus may preprocess the time-series battery signal obtained from the sensor so as to be a form suitable for data processing, as discussed above, and generate the segment data including successive sensor signals of a fixed magnitude for a predetermined amount of time.

In operation 930, the battery state estimating apparatus may calculate a battery state probability value by projecting the segment data to a feature space.

The battery state estimating apparatus may extract feature data by transforming a feature space of the segment data. Here, the segment data may be transformed into a low-dimensional feature data vector based on a prelearned feature space transformation model.

The battery state estimating apparatus may probabilistically infer a battery state of a target battery using a prelearned battery state probability density model. The battery state estimating apparatus may infer a normal or abnormal state probability value of the segment data in the low-dimensional feature space based on the learned battery state probability density model of each battery state, for example, the normal or abnormal state. The inferring of the battery state probability value, for example, the normal or abnormal state probability value, may be performed based on a single set of the segment data, or an average value of probability values inferred from successive sets of the segment data, as only examples.

In operation 940, the battery state estimating apparatus may estimate the battery state of the target battery based on the inferred normal or abnormal probability value. The battery state estimating apparatus may determine whether the segment data extracted from the battery sensor signal follows a normal state probability pattern or an abnormal state probability pattern based on the prelearned battery state estimation model. The battery state estimating apparatus may then output, e.g., to a display of the driver or a user of an electric vehicle, the estimated battery state.

The apparatuses, units, modules, devices, and other components illustrated in FIGS. 1-2 and 8, for example, that may perform operations described herein with respect to FIGS. 3-7 and 9, for example, are implemented by hardware components. Examples of hardware components include controllers, sensors, memory, drivers, resistors, capacitors, inductors, power supplies, frequency generators, operational amplifiers, power amplifiers, low-pass filters, high-pass filters, band-pass filters, analog-to-digital converters, digital-to-analog converters, and any other electronic components known to one of ordinary skill in the art. In one example, the hardware components are implemented by one or more processing devices, or processors, or computers. A processing device, processor, or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processing device, processor, or computer includes, or is connected to, one or more memories storing instructions or software that are executed by the processing device, processor, or computer and that may control the processing device, processor, or computer to implement one or more methods described herein. Hardware components implemented by a processing device, processor, or computer execute instructions or software, such as an operating system (OS) and one or more software applications that run on the OS, to perform the operations described herein with respect to FIGS. 3-7 and 9, as only an example. The hardware components also access, manipulate, process, create, and store data in response to execution of the instructions or software. For simplicity, the singular term “processing device”, “processor”, or “computer” may be used in the description of the examples described herein, but in other examples multiple processing devices, processors, or computers are used, or a processing device, processor, or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, remote processing environments, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 3-7 and 9 that perform the operations described herein may be performed by a processing device, processor, or a computer as described above executing instructions or software to perform the operations described herein.

Instructions or software to control a processing device, processor, or computer to implement the hardware components and perform the methods as described above may be written as computer programs, code segments, instructions or any combination thereof, for individually or collectively instructing or configuring the processing device, processor, or computer to operate as a machine or special-purpose computer to perform the operations performed by the hardware components and the methods as described above. In one example, the instructions or software include machine code that is directly executed by the processing device, processor, or computer, such as machine code produced by a compiler. In another example, the instructions or software include higher-level code that is executed by the processing device, processor, or computer using an interpreter. Based on the disclosure herein, and after an understanding of the same, programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processing device, processor, or computer to implement the hardware components, such as discussed in any of FIGS. 1-2 and 8, and perform the methods as described above in any of FIGS. 3-7 and 9, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processing device, processor, or computer so that the processing device, processor, or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processing device, processor, or computer.

As only an example, a processing device configured to implement a software or computer readable code component to perform an operation A may include a processor programmed to run software or execute computer readable code or instructions to control the processor to perform operation A. In addition, a processing device configured to implement a software or computer readable code component to perform an operation A, an operation B, and an operation C may have various configurations, such as, for example, a processor configured to implement a software or computer readable code component to perform operations A, B, and C; a first processor configured to implement a software or computer readable code component to perform operation A, and a second processor configured to implement a software or computer readable code component to perform operations B and C; a first processor configured to implement a software or compute readable code component to perform operations A and B, and a second processor configured to implement a software or computer readable code component to perform operation C; a first processor configured to implement a software or computer readable code component to perform operation A, a second processor configured to implement a software or computer readable code component to perform operation B, and a third processor configured to implement a software or computer readable code component to perform operation C; a first processor configured to implement a software or computer readable code component to perform operations A, B, and C, and a second processor configured to implement a software or computer readable code component to perform operations A, B, and C, or any other configuration of one or more processors each implementing one or more of operations A, B, and C. Although these examples refer to three operations A, B, C, the number of operations that may implemented is not limited to three, but may be any number of operations required to achieve a desired result or perform a desired task.

As a non-exhaustive example only, an electronic device embodiment herein, e.g., that includes an apparatus estimating a state of a battery, as described herein, may be a vehicle, a mobile device, such as a cellular phone, a smart phone, a wearable smart device, a portable personal computer (PC) (such as a laptop, a notebook, a subnotebook, a netbook, or an ultra-mobile PC (UMPC), a tablet PC (tablet), a phablet, a personal digital assistant (PDA), a digital camera, a portable game console, an MP3 player, a portable/personal multimedia player (PMP), a handheld e-book, a global positioning system (GPS) navigation device, or a sensor, or a stationary device, such as a desktop PC, a high-definition television (HDTV), a DVD player, a Blu-ray player, a set-top box, or a home appliance, or any other mobile or stationary device capable of wireless or network communication.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is not limited by the detailed description, but further supported by the claims and their equivalents, and all variations within the scope of the claims and their equivalents are to be construed as being included in the disclosure.

What is claimed is:

1. An apparatus for learning a battery state estimation model, comprising:
a signal processor configured to segment a battery signal into sets of segment data at a predetermined time interval; and
a learner, as one or more processing devices, configured to learn a battery state estimation model, for estimating a battery state of a battery, based on a determined battery state probability density of the segment data.

2. The apparatus of claim 1, wherein the signal processor comprises:
a preprocessor configured to correct the battery signal so that an interval that the battery signal was collected from the battery is changed to a regular time interval and configured to perform an elimination of noise from the battery signal.

3. The apparatus of claim 1, wherein the learner comprises:
a feature space transformation model learner configured to learn a feature space transformation model corresponding to a battery state feature by projecting the sets of the segment data to a corresponding feature space;
a battery state probability density model learner configured to learn the battery state probability density model to estimate a battery state probability value using the learned feature space transformation model; and
a battery state estimation model learner configured to learn the battery state estimation model to estimate a battery state using the battery state probability density model.

4. The apparatus of claim 3, wherein the feature space transformation model learner is configured to learn the feature space transformation model by projecting the sets of the segment data to the corresponding feature space in a dimension lower than a current dimension of the segment data, using at least one of a principle component analysis, a linear discriminant analysis, a nonnegative matrix factorization, and an independent component analysis.

5. The apparatus of claim 3, wherein the battery state probability density model learner is configured to estimate a parameter of the battery state probability density model defined by at least one of a maximum likelihood algorithm and a maximum a posteriori (MAP) algorithm using the learned feature space transformation model.

6. The apparatus of claim 1, wherein the learner is configured to determine a threshold value parameter that indicates a battery state to be a normal state in response to an estimated battery state probability value meeting a predetermined threshold value based on the determined battery state probability density corresponding to the learned battery state estimation model, and configured to reflect the determined threshold value parameter in the battery state estimation model.

7. A battery state estimating apparatus, comprising:
a signal processor configured to segment a battery signal into sets of segment data at a predetermined time interval; and
a state estimator, as one or more processing devices, configured to estimate a battery state of a battery based on an estimated battery state probability value of the segment data with respect to a learned battery state estimation model.

8. The apparatus of claim 7, wherein the signal processor comprises:
a preprocessor configured to correct the battery signal so that an interval that the battery signal was collected from the battery is changed to a regular time interval and configured to perform an elimination of noise from the battery signal.

9. The apparatus of claim 7, wherein the state estimator is configured to estimate the battery state based on an average of battery state probability values estimated from successive sets of the segment data.

10. The apparatus of claim 7, wherein the learned battery state estimation model comprises a battery state probability density model learned using reference segment data of a battery signal previously measured from a reference battery.

11. The apparatus of claim 7, wherein the state estimator comprises:
a feature extractor configured to extract a feature of the battery state by projecting the segment data to a feature space; and
a battery state probability inferrer configured to infer a probability of the battery state using a battery state probability density model corresponding to the battery state.

12. The apparatus of claim 7, further comprising a learner configured to learn the battery state estimation model using a determined battery state probability density of reference segment data.

13. The apparatus of claim 12, wherein the learner comprises:
a feature space transformation model learner configured to learn a feature space transformation model corresponding to a battery feature state by projecting sets of the reference segment data to a feature space;
a battery state probability density model learner configured to learn a battery state probability density model to estimate the battery state probability value using the learned feature space transformation model; and
a battery state estimation model learner configured to learn the battery state estimation model for estimating battery states using the learned battery state probability density model.

14. A battery state estimating method, comprising:
segmenting a battery signal into sets of segment data at a predetermined time interval;
calculating an estimated battery state probability value of the segment data with respect to a learned battery state estimation model; and
estimating a battery state of a battery based on the calculated estimated battery state probability value.

15. The method of claim 14, wherein the segmenting comprises:
correcting the battery signal so that an interval that the battery signal was collected from the battery is changed to a regular time interval; and
performing an elimination of noise from the battery signal.

16. The method of claim 14, wherein the learned battery state estimation model is generated from a battery state probability density model learned using reference segment data of a battery signal previously measured from a reference battery.

17. The method of claim 16, further comprising learning the battery state estimation model based on the learned battery state probability density model.

18. The method of claim 16, wherein the battery state probability density model comprises a normal state estimation model corresponding to a normal state of the reference battery and an abnormal state estimation model corresponding to an abnormal state of the reference battery.

19. The method of claim 16, wherein the battery state probability density model is generated from a feature space transformation model corresponding to a feature of the battery state by projecting the reference segment data to a corresponding feature space.

20. A non-transitory computer-readable storage medium comprising computer readable code to control at least one processing device to implement the method of claim 14.
